(19) United States
(12) Patent Application Publication
(10) Pub. No.: US 2025/0198187 A1
(43) Pub. Date: Jun. 19, 2025

(54) SURF POOL WITH CONTROLLED ENTRANCE GATE

(71) Applicant: Thomas J. Lochtefeld, San Diego, CA (US)

(72) Inventor: Thomas J. Lochtefeld, San Diego, CA (US)

(21) Appl. No.: 18/975,403

(22) Filed: Dec. 10, 2024

Related U.S. Application Data
(60) Provisional application No. 63/610,049, filed on Dec. 14, 2023.

(51) Int. Cl. E04H 4/14; A63B 69/00; E04H 4/00; E05B 47/00; E06B 11/02

(52) U.S. Cl. CPC E04H 4/144; E04H 4/0006; E05B 47/0002; E06B 11/022; A63B 69/0093; E05B 2047/0068

(57) ABSTRACT

The present invention comprises a wave pool with at least one sidewall with an opening thereon having a gate that can be opened and closed for enabling surfers to enter into and exit from the wave pool, wherein means are provided that enable the gate to be opened and closed and locked, depending on the status of the wave generators and whether waves are being generated in the wave pool.

### RELATED APPLICATIONS

This is a non-provisional application which claims the benefit of the filing date of U.S. Provisional Application Ser. No. 63/610,049, filed on Dec. 14, 2023.

### FIELD OF THE INVENTION

The present invention relates to the field of wave pools, and in particular, to a wave pool that comprises at least one sidewall with an opening thereon comprising a gate for enabling surfers to enter into and exit from the wave pool, wherein means are provided that enable the gate to be opened and closed and locked, depending on the status of the wave generators and whether waves are being generated or not.

### BACKGROUND OF THE INVENTION

Wave pools are man-made bodies of water in which waves are artificially created to simulate waves in an ocean.

A wave pool typically has a sidewall on either side, along with one or more wave generating devices at one end and an artificial sloped “beach” located at the other end, wherein the wave generating devices create disturbances in the water that produce waves that travel from one end to the other. The floor of the shoreline is preferably sloped upward so that as the waves approach, the floor causes the waves to change shape and “break” onto the beach.

Some wave pools have multiple wave generators positioned side by side along the deep end, which are capable of being activated to produce a single wave that travels from the deep end to the shallow end. Typically, in such a case, each wave generator can be activated at the same time or progressively to simultaneously create a single resultant wave that progresses across the wave pool and breaks.

To create multiple waves, this activation must be repeated, one after another, wherein after one wave travels across the wave pool, the wave generators must be refilled and reactivated to create the next wave. And each time a new wave is created, the water level in the wave pool fluctuates up and down, as the waves rise to form crests and then drop as they recede during the second half of each wave cycle, wherein the waves eventually break and dissipate along the shore.

Although most wave pools of this kind are designed to enable participants to wade gently within the water, to produce large surfable waves, the wave pool must be larger, and the wave generators themselves must be more powerful, sufficient to push more water across the wave pool to create larger and more dramatic wave effects.

When large surfing wave pools are developed, they must be constructed to take into account the difficulties and challenges associated with the art of surfing. Generally speaking, surfing requires a combination of natural ability, skill and practice, wherein the surfer must learn to make continual adjustments while standing on a longitudinally oriented surfboard as it skims forward across a wave, such that while the surfer leans and makes adjustments to carve out the proper path, he or she must remain balanced and be propelled forward at just the right velocity and angle. In this respect, surfing requires the surfer to keep the board in a constantly changing equilibrium state, while maintaining constant awareness of his or her position relative to the board, and the board's position relative to the wave, wherein the board and surfer are synchronized together while moving forward at various angles and directions, and performing maneuvers using gravity and the sloped surface of the moving wave.

Because of the need to synchronize these movements carefully, it is important for the waves in the wave pool to be consistent from one wave to the next, and for the surfer to be able to enter into the wave pool at just the right moment and at just the right location, sufficient to enable him or her to generate enough speed, to not only ride the wave successfully, but to use the ramps, transitions, sections and hollow tubes that are created on the waves to perform various tricks and maneuvers thereon. In other words, it is important that the waves on which the board travels on, and cuts across, is sufficiently supported to create a smooth wave surface, free of turbulences and discontinuities, to thus allow the surfer to perform the desired maneuvers. If there are any irregularities in the wave's structure, such as ridges, angles, ripples, vortices, chops, etc., the wave will be difficult to maneuver across and stay balanced on.

And given the size of a standard surf board, which will also need to be carried by the surfer into the wave pool at the same time, it is also important that the smooth portion of the wave be sufficiently large/wide enough such that the surf board can be fully supported by the wave structure, wherein, as the board skims and maneuvers across the wave, the surfer must be able to make the necessary adjustments to stay balanced and move forward while performing maneuvers thereon. If there is too much turbulence, for example, or if the smooth portion of the wave is not large/wide enough, the board can be diverted, or misdirected, which can force the surfer to have to make quick compensating adjustments, which can increase the chance of a wipe out.

For all of the above reasons, a need exists to design and build a wave pool with sidewalls that have one or more openings thereon that can be opened and closed and locked during various wave generating sequences to enable surfers to enter into and exit from the wave pool at just the right moment and at just the right location. For this purpose, a gate can be used and locked at the appropriate time, depending on when the wave generators are turned on and off, and when the waves are being formed and travelling across the wave pool, thus enabling the waves to travel across the wave pool and be fully supported and maintained in a smooth and consistent manner that enables the surfers to stay balanced and perform maneuvers thereon.

### SUMMARY OF THE INVENTION

The present invention represents an improvement over previous wave pool designs insofar as the present invention comprises a wave pool having at least one wave generator, at least one sidewall and a sloped beach, which includes a gateway opening on at least one sidewall for enabling surfers to enter into and exit from the wave pool at just the right moment and at just the right location, wherein various embodiments are provided that overcome the disadvantages of previous wave pool designs.

In one aspect, the present invention comprises a gateway opening on at least one sidewall, wherein the bottom edge of the gateway opening is extended above the standing mean water level of the wave pool, such that when the gateway opening is open, surfers can enter into and exit from the wave pool without water spilling into the gateway opening. In another aspect, the gateway opening preferably has a hinged gate extended within the gateway opening that enables the gateway opening to be opened and closed, wherein when the hinged gate is open, surfers or participants can pass through the gateway opening and into and out of the wave pool, and when the hinged gate is closed, it substantially prevents water and wave energy in the wave pool from passing into and through the gateway opening, and thus prevents interference with the formation and forward progress of the waves.

In another aspect, the present invention comprises a control mechanism or logic control connected to the wave generators and the hinged gate wherein the control mechanism is adapted to sense when the wave generators are turned on, and to sense when the wave generators are turned off, wherein the control mechanism is capable of locking the hinged gate when it senses that the wave generators are turned on or otherwise creating waves in the wave pool, and is capable of unlocking the hinged gate when it senses that the wave generators are turned off or otherwise not creating waves in the wave pool, or has been turned off for a predetermined amount of time, such as 4 to 10 seconds.

In another aspect, the present invention comprises incorporating a gateway opening on a sidewall that is sized and shaped to enable participants carrying surfboards to easily pass through the gateway opening, wherein the hinged gate has at least one hinge that allows it to swing open in one direction away from the wave pool. In another aspect, the hinged gate preferably comprises a frame with a clear window extended across it that enables participants to see into the wave pool, wherein an entrance area with a grated floor is preferably provided adjacent the hinged gate, and a cavity or reservoir is provided below the entrance area for enabling excess water drained from the entrance area to be circulated back into the wave pool.

In another aspect, the wave pool of the present invention comprises a locking mechanism on the hinged gate comprising a pair of electromagnetic locks that are connected to and can be controlled by the control mechanism, wherein sensors are provided on the hinged gate and/or locking mechanism so that the control mechanism can sense when the hinged gate is open or closed. In another aspect, the hinged gate preferably has a gasket or sealing member thereon such that with the hinged gate closed, the gateway opening is substantially sealed such that water in the wave pool is substantially prevented from passing into and through the gateway opening.

In another aspect, the present wave pool preferably comprises a secondary hinged gate that is narrower than the hinged gate, wherein the secondary gate is hinged on the side opposite the hinged gate, wherein in a closed position, the secondary gate is adapted to be positioned substantially parallel to and secured to the hinged gate, such that it blocks and substantially prevents the hinged gate from being opened, and wherein in an open position, the secondary gate can swing away from the wave pool, and be disconnected from the hinged gate, and thus enable the hinged gate to swing open.

In another aspect, the secondary hinged gate has latches that are controlled manually by a handle, wherein the secondary gate can be opened and closed by using the handle, and wherein with the secondary gate in the closed position, the latches are adapted to latch onto complimentary locks extended on the hinged gate such that the secondary gate overlaps and extends parallel to the hinged gate and blocks and prevents the hinged gate from opening, and in the open position, the secondary gate can be swung open to enable the hinged gate to be swung open.

In another aspect, additional sensors are preferably provided on the secondary gate and/or the latches to enable the control mechanism to sense when the secondary gate is open or closed, wherein when the secondary gate is open, the control mechanism ensures that the wave generators are turned off and remain off, and when the secondary gate is closed, the control mechanism senses that it would be ok for the wave generators to be turned on and for waves to be generated in the wave pool.

In another aspect, the present wave pool comprises an activation button on the inside of the sidewall which can be activated by a surfer or lifeguard while inside the wave pool, wherein the activation button enables the hinged gate located on the gateway opening to be opened when the wave generators are turned off, and there is no wave activity in the wave pool. In such a case, the activation button can comprise a pressure activated switch and the logic control can include sensors to determine when the wave generators are turned off, in which case, the locking mechanisms on the gate can be unlocked to enable the hinged gate to be opened, depending on the status of the wave generators and waves. That way, when the wave generators are turned on or when wave activity is sensed within the wave pool, the locking mechanisms can keep the gate closed and locked. On the other hand, when the wave generators are turned off and there is no wave activity in the wave pool, the locking mechanisms can be unlocked to enable the gate to be opened.

The present invention also comprises a method of entering into and/or exiting from a wave pool having at least one wave generator and a sloped beach, and at least one sidewall comprising providing at least one gateway opening along with a hinged gate extended within the gateway opening wherein the hinged gate can be opened and closed and locked using a locking mechanism.

In another aspect, the method comprises providing a logic control connected to the wave generator, on one hand, and the hinged gate or locking mechanism, on the other hand, and operating the logic control to lock and unlock the hinged gate, and using the logic control to lock the hinged gate when the wave generators are turned on and creating waves in the wave pool, and to unlock the hinged gate when the wave generators are turned off and not creating waves in the wave pool, or a predetermined amount of time thereafter such as 4 to 10 seconds. In another aspect, the locking mechanism comprises a pair of electromagnetic locks wherein operating the logic control enables the hinged gate to be opened and closed and placed in a locked position.

In another aspect, the present invention comprises setting the predetermined amount of time to 4 to 10 seconds such that the hinged gate can be unlocked 4 to 10 seconds after the wave generators are turned off and no longer creating waves in the wave pool, wherein sufficient time can be provided for the waves to subside and calm down before the hinged gate is unlocked and allowed to be opened.

In another aspect, the present method comprises using a secondary hinged gate with a handle and latches that can lock the secondary gate in a closed position, wherein with the secondary gate in the closed position, the hinged gate and the secondary gate are extended parallel to each other and secured together such that the secondary gate helps block and prevent the hinged gate from being opened.

In another aspect, the present method comprises turning the handle and unlocking the latches and allowing the secondary gate to be swung open and thus separating the hinged gate from the secondary gate, and thus allowing the hinged gate to be swung open, thus enabling surfers to enter into and/or exit from the wave pool.

In another aspect, the present method comprises manually closing the hinged gate until it is locked, followed by manually closing the secondary gate until the latches are connected to complimentary connectors on the hinged gate so that both the hinged gate and the secondary gate are locked and secured together, which blocks and prevents the hinted gate from being swung open.

In another aspect, the present method comprises using the logic control to sense that the locking mechanism is keeping the hinged gate in a closed position, and turning on or allowing the wave generators to be turned on to create waves in the wave pool, wherein by keeping the hinged gate closed and locked, water and wave energy in the wave pool can be prevented from spilling into and through the gateway opening and into an entrance area adjacent the gateway opening as the waves pass by.

In another aspect, the present method comprises using the logic control to sense that the locking mechanism has allowed the hinged gate to be opened, and not allowing the wave generators to be turned on to create waves in the wave pool, wherein by keeping the hinged gate unlocked, surfers can open the hinged gate and enter into and/or exit from the wave pool through the gateway opening.

In another aspect, the present method can comprise providing an activation button on the inside of the sidewall and enabling surfers or lifeguards to press the activation button while inside the wave pool, wherein the hinged gate can be opened and closed by locking and unlocking the locking mechanisms when needed. The logic control, in such a case, can be adapted with sensors such that when the wave generators are turned off and there is no wave activity in the wave pool, the hinged gate can be opened, and when the wave generators are turned on and there is wave activity in the wave pool, the hinged gate can remain locked. Note, this embodiment is designed to be used without the secondary hinged gate, which can block the opening of the hinged gate and which would need to be unlocked manually to enable the hinged gate to be opened and closed.

### BRIEF DESCRIPTION OF THE DRAWINGS

FIG. 1 is a perspective view of the wave pool of the present invention with multiple wave generators located on one end, with two sidewalls extended on either side, wherein a gateway opening with a hinged gate is provided on each sidewall for enabling surfers to enter into and exit from the wave pool, wherein this view shows the hinged gates closed and locked, which is appropriate and desired when the wave generators are turned on and waves are being formed in the wave pool;

FIG. 2 is a perspective view of the wave pool of the present invention with multiple wave generators located on one end, with two sidewalls extended on either side, wherein a gateway opening with a hinged gate is provided on each sidewall for enabling surfers to enter into and exit from the pool, wherein this view shows the hinged gates opened, which is appropriate and desired when the wave generators are turned off and water in the pool is relatively calm, wherein the standing mean water level in the wave pool is extended below the bottom edge of the gateway opening;

FIG. 3 is a schematic drawing showing a logic control that is wired and connected to the wave generators on one end and wired to the top and bottom electromagnetic locks on the gateway opening on the other end;

FIG. 4 is a perspective view of the hinged gate extended within the gateway opening on a sidewall showing the hinges on one side and a gate closing mechanism, which in the preferred embodiment is a secondary hinged gate, which is much narrower than the hinged gate, extended with a hinge and a handle on the opposite side;

FIG. 5 is a perspective view of the hinged gate extended within the gateway opening on a sidewall showing 1) the electromagnetic locks with sensors on the top and bottom of the hinged gate, along with a central linkage mechanism, 2) the secondary hinged gate for preventing the hinged gate from opening, and 3) complimentary connectors for latching the secondary hinged gate to the hinged gate;

FIG. 5a is a detail of the perspective view shown in FIG. 5 showing 1) one of the two complimentary connectors for latching the secondary hinged gate to the hinged gate, 2) the central linkage mechanism for controlling the electromagnetic locks on the top and bottom of the hinged gate, and 3) the secondary hinged gate with handle and latch for preventing the hinged gate from opening;

FIG. 6 is an elevation view of the hinged gate extended within the gateway opening of a sidewall showing the hinged gate in a closed and locked position, wherein the top and bottom electromagnetic locks and the complimentary connectors for latching the secondary hinged gate to the hinged gate are shown, wherein for clarity purposes, this view omits the secondary hinged gate;

FIG. 7 is a top view of the hinged gate extended within the gateway opening of a sidewall showing the hinged gate being swung open, wherein for clarity this view omits the secondary hinged gate;

FIG. 8 is an elevation view of the hinged gate (shown in dashed lines) extended within the gateway opening of a sidewall, showing a secondary hinged gate for locking the hinged gate, wherein the secondary hinged gate comprises a handle and latch for locking onto the hinged gate, wherein with the secondary hinged gate in a locked position, it blocks and prevents the hinged gate from being opened;

FIG. 9 is a top view of the hinged gate (shown in dashed lines) extended within the gateway opening, with the secondary hinged gate unlocked and swung partially open;

FIG. 10 is a top view of the hinged gate extended within the gateway opening of a sidewall showing both the hinged gate and the secondary hinged gate in a closed and locked position, wherein with the secondary hinged gate latched and locked, the hinged gate and secondary hinged gate are secured together and the secondary hinged gate block and prevents the hinged gate from being opened;

FIG. 11 is a top view of the hinged gate extended within the gateway opening of a sidewall showing the hinged gate in a closed position, but with the secondary hinged gate unlatched and swung open; and

FIG. 12 is a top view of the hinged gate extended within the gateway opening of a sidewall showing the secondary hinged gate and hinged gate both swung to an open position.

### DETAILED DESCRIPTION OF THE INVENTION

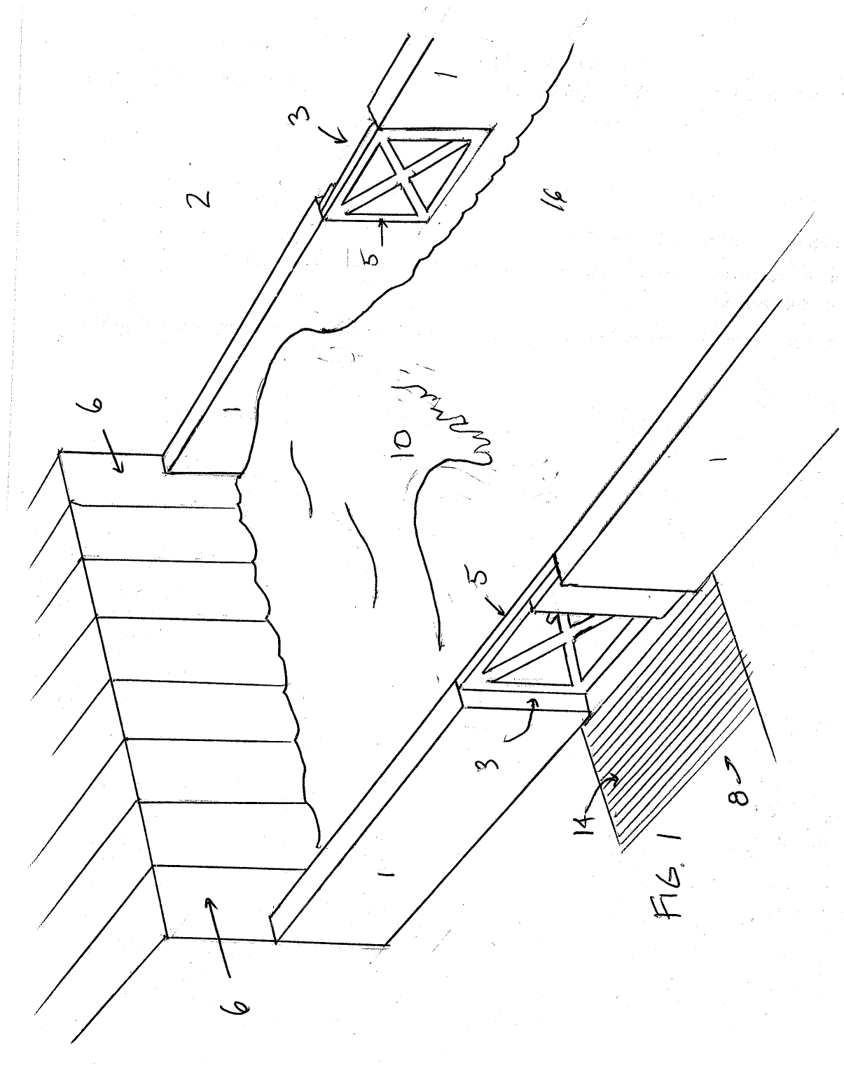

The present invention relates to a wave pool 2 with multiple wave generators 6 extended along one end and a sloped beach extended along the other end (not shown), and two sidewalls 1 extended between them on either side, as shown in FIG. 1, wherein wave generators 6 are designed to be turned on and off to create surfable waves 10 that travel across wave pool 2 from one end to the other. At least one gateway opening 3 is preferably provided on one or both sidewalls 1, through which surfers can enter into and exit from wave pool 2 at or near the surface of the water 16 in wave pool 2.

Gateway opening 3 is preferably rectangular in shape, although not necessarily so, and sufficiently wide enough to enable surfers and their surfboards to be easily passed through and maneuvered into and from wave pool 2. The bottom edge 33 of gateway opening 3 is preferably located above the standing mean water level of wave pool 2, as shown in FIG. 2, or preferably about 6 inches above it, such that when gateway opening 3 is opened, water in wave pool 2 does not spill into and through gateway opening 3.

Accordingly, when wave generators 6 are turned off, and the water 16 in wave pool 2 is relatively calm, gateway opening 3 can remain open, such that surfers can enter into and exit from wave pool 2 without any water in wave pool 2 spilling into and through gateway opening 3 and into entrance area 8. Note, even if some water from wave pool 2 does spill into and through gateway opening 3, and into entrance area 8, a grated floor 14 is preferably provided within entrance area 8, which drains excess water down into a cavity or reservoir (not shown) adjacent wave pool 2, wherein the drained water can then be circulated back through an opening into wave pool 2.

Gateway opening 3 is preferably provided with a hinged gate 5 with a hinge 4, as shown in FIG. 4, that can be used to close/shut/seal gateway opening 3 when needed, i.e., hinged gate 5 is preferably adapted to swing open in a direction away from wave pool 2 and be swung back to be closed and locked.

When hinged gate 5 is open, as described above, surfers can freely enter into and exit from wave pool 2, wherein they can easily jump or slide into wave pool 2 and swim to the middle thereof and wait for waves 10 to form and travel across wave pool 2 so that they can catch the next wave and surf thereon.

On the other hand, when hinged gate 5 is closed and locked, and gateway opening 3 is shut/sealed, waves 10 can be formed within wave pool 2 such that they travel across wave pool from one end to the opposite end, wherein hinged gate 5 substantially prevents water and wave energy from spilling into and through gateway opening 3 and thus prevents water from spilling and crashing into entrance area 8 (adjacent gateway opening 3), which helps prevent interference with waves 10 so that they are not disturbed as they travel across wave pool 2.

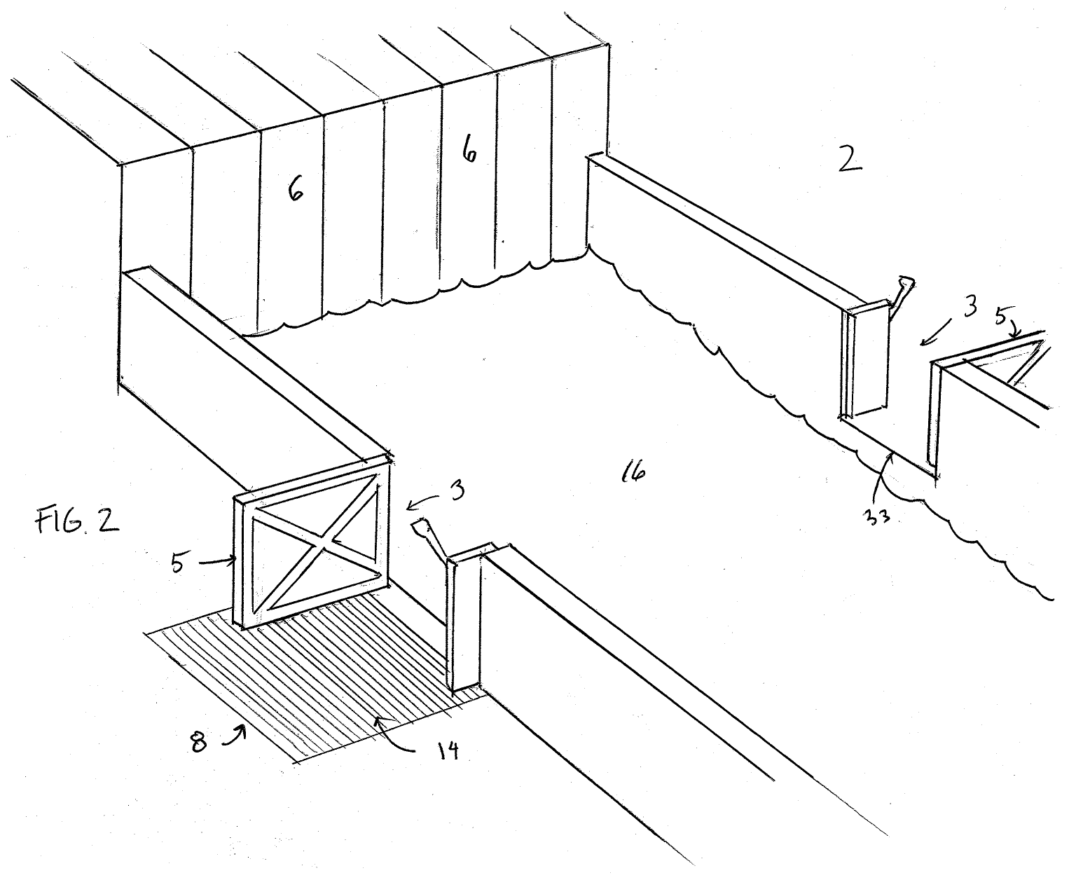

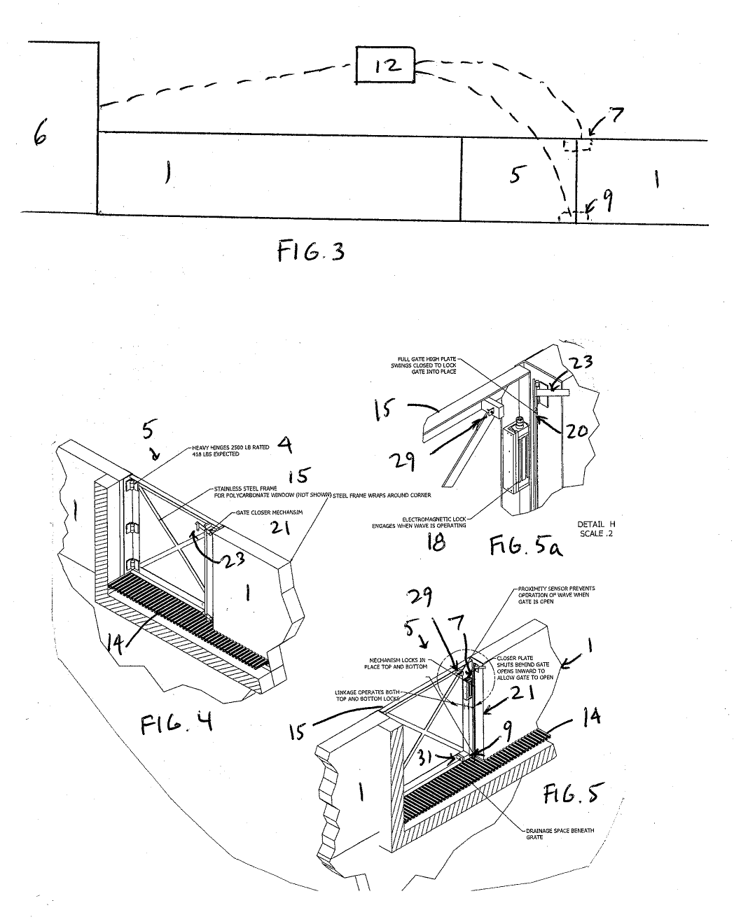

A logic control 12, as schematically shown in FIG. 3, is preferably connected to each of the multiple wave generators 6 and gate locking mechanisms, 7, 9, such that when wave generators 6 are turned on, a sensor detects this and a signal can be sent to locking mechanisms 7, 9, to lock hinged gate 5. On the other hand, when wave generators 6 are turned off, or a short time thereafter, i.e., within a few seconds, such as 4 to 10 seconds, to allow waves 10 to subside, a sensor detects this and a signal can be sent to locking mechanisms 7, 9, which unlocks hinged gate 5 and allows it to be opened, such as manually, to allow surfers to pass through gateway opening 3.

Hinged gate 5 is preferably hinged 4 on one side and sized and shaped to span and fill the entire gateway opening 3, such that when hinged gate 5 is closed, it seals and prevents water 16 from waves 10 from spilling and crashing into entrance area 8 from wave pool 2. Hinged gate 5 is preferably made of a rigid stainless steel or metal frame 15, as shown in FIG. 4, which is connected to hinge 4, along with a clear plexiglass or polycarbonate window 17, extended within frame 15, so that surfers can see through hinged gate 5 and into wave pool 2. Hinged gate 5 is preferably sturdy and strong enough on both the hinge-side 11 and locking-side 13, as shown in FIGS. 6 and 8, to withstand the pressures created and applied to hinged gate 5 as the energy and weight of multiple waves 10 pass by.

Hinged gate 5 preferably has a gasket or other sealing means 19 along its edges to seal hinged gate 5 against gateway opening 3 and thus prevent water 16 from leaking through gateway opening 3. Preferably, hinged gate 5 swings open in only one direction, which is away from wave pool 2, as shown in FIGS. 2, 7 and 12, wherein retention members 27 shown in FIG. 12 are preferably provided on the pool-side to prevent hinged gate 5 from opening in a reverse direction, i.e., toward wave pool 2.

Entrance area 8 is preferably provided with a grated floor 14, shown in FIG. 5, to drain excess water 16 that may spill into entrance area 8 from wave pool 2 down and into a cavity or reservoir (not shown) from which excess water can be circulated back into wave pool 2.

Hinged gate 5 preferably comprises a double-lock system as follows:

First, to keep hinged gate 5 closed and locked, locking mechanisms 7, 9 preferably comprise a pair of electromagnetic locks, as shown in FIGS. 5 and 6—one at the top of hinged gate 5 and another at the bottom—which are operated by a central linkage mechanism 18, wherein these electromagnetic locks, 7, 9, are designed to be remotely controlled and actuated via logic control 12, so that hinged gate 5 can be locked and unlocked remotely based on input from logic control 12. When electromagnetic locks 7, 9 are locked, hinged gate 5 cannot be opened, and when electromagnetic locks 7, 9 are unlocked, hinged gate 5 can be opened manually.

The invention also contemplates using other types of locking mechanisms that function in a similar manner, other than electromagnetic locks. In this respect, when referring to locking mechanisms, 7, 9, it is intended that they can comprise electromagnetic locks or any other adequate types of locks.

Second, a manually operated gate closing mechanism, or secondary hinged gate 21, as shown in FIGS. 4 to 5, and FIGS. 8 to12, with handle 23 and latches 20 (hidden within secondary hinged gate 21) is preferably provided to keep hinged gate 5 in a closed and locked position and prevent it from being opened. Secondary hinged gate 21 is preferably much narrower than hinged gate 5 and designed like a miniature narrow door that preferably extends the full height of gateway opening 3, but not the entire width thereof, and preferably it has at least two hinges 25 on the opposite side of gate hinges 4.

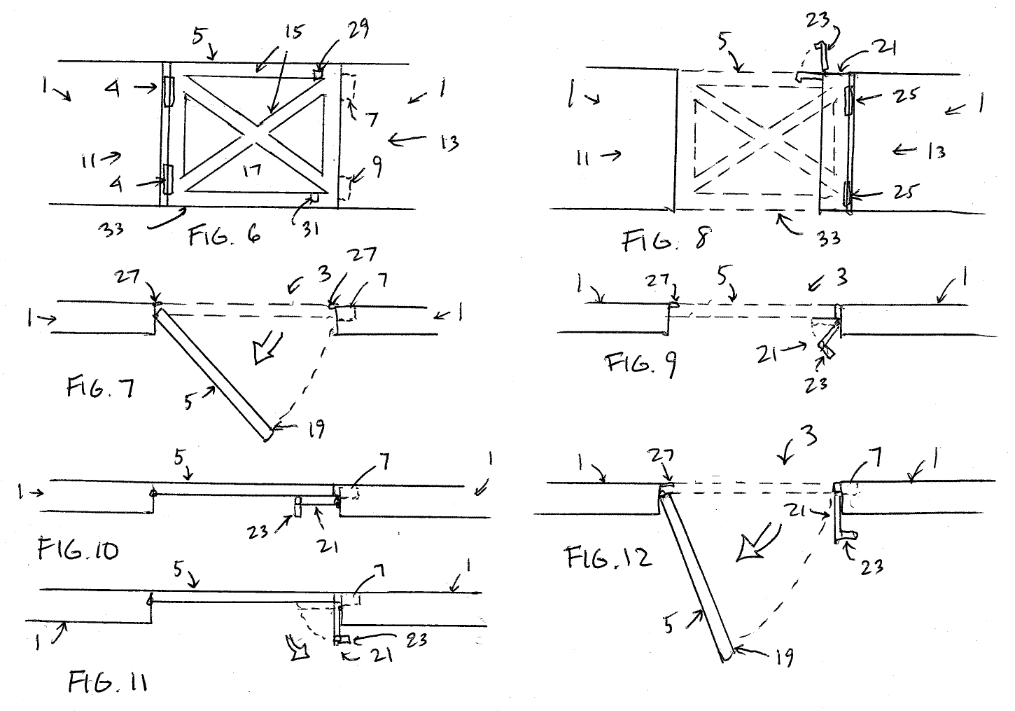

Secondary hinged gate 21 is preferably designed to open and close and partially overlap and extend substantially parallel to hinged gate 5 so that when secondary hinged gate 21 is closed, latched and locked, it blocks and prevents hinged gate 5 from being opened. In a closed position, both hinged gate 5 and secondary hinged gate 21 are extended parallel to each other and overlap one another, as shown in FIG. 10, and are secured together by latches 20 and prevented from being separated. Handle 23 on secondary hinged gate 21 is preferably used manually to enable latches 20 to be locked and unlocked onto complimentary connectors 29 and 31 on hinged gate 5, as shown in FIGS. 5 and 6, such that with secondary hinged gate 21 closed, latched and locked, hinged gate 5 cannot be opened, but with secondary hinged gate 21 open, hinged gate 5 can also be opened.

In such a case, the only way hinged gate 5 can be opened is by manually turning handle 23 on secondary hinged gate 21, and unlocking latches 20, and manually swinging secondary hinged gate 21 open, wherein secondary hinged gate 21 unblocks hinged gate 5, such that hinged gate 5 can be swung open manually (so long as electromagnetic locks 7, 9 on hinged gate 5 are unlocked using logic control 12). Then, to repeat the steps, after closing hinged gate 5, and to prevent hinged gate 5 from reopening prematurely, secondary hinged gate 21 can be swung back and locked with latches 20, using handle 23 to connect latches 20 onto complimentary connectors 29 and 31, wherein by virtue of secondary hinged gate 21 being extended parallel to and overlapping hinged gate 5, secondary hinged gate 21 blocks and prevents hinged gate 5 from being opened.

Logic control 12 preferably has a timing mechanism and works with sensors, along with wiring that connects logic control 12 to locking mechanisms 7, 9 such as electromagnetic locks and wave generators 6. Sensors on wave generators 6 sense when wave generators 6 are turned on and off, wherein logic control 12 can send and receive signals to lock and unlock locking mechanisms 7, 9, based on whether wave generators 6 are turned on or off. That way, when wave generators 6 are turned on, and waves 10 are being created in wave pool 2, locking mechanisms 7, 9 keep hinged gate 5 locked, thus preventing hinged gate 5 from being opened prematurely. But when wave generators 6 are turned off, and preferably, after a predetermined amount of time, such as 4 to 10 seconds (which allows time for the waves to subside and dissipate), logic control 12 can send a signal to locking mechanisms 7, 9, to unlock hinged gate 5 and thus enable hinged gate 5 to be opened manually.

Manual opening of hinged gate 5 can be accomplished by first using handle 23 to unlock latches 20 on secondary hinged gate 21, as explained above, which allows secondary hinged gate 21 to be manually swung open, which allows hinged gate 5 to be manually opened (subject to locking mechanisms 7, 9 being unlocked by logic control 12).

Logic control 12 preferably prevents hinged gate 5 from opening while wave generators 6 are turned on, whereas, when wave generators 6 are turned off, or at least a few seconds thereafter, logic control 12 can be used to unlock locking mechanisms 7, 9, such as electromagnetic locks, and thus allow hinged gate 5 to be opened manually.

Additional sensing mechanisms can also be used and adapted to sense when locking mechanisms 7, 9 are locked and unlocked. That way, when hinged gate 5 is unlocked, logic control 12 can detect this and send a signal to prevent wave generators 6 from being turned on. Likewise, when hinged gate 5 and locking mechanisms 7, 9 are locked, logic control 12 can detect this and send a signal to wave generators 6 to allow them to be turned on, wherein the timing mechanism can determine how long wave generators 6 must stay off before they can be turned back on.

An additional sensing mechanism can also be set up and connected to sense when latches 20 on secondary hinged gate 21 are locked and unlocked. That way, as an additional layer of protection, logic control 12 can detect whether or not latches 20 on secondary hinged gate 21 are locked, and thus, it can send a signal to logic control 12 to allow wave generators 6 to be turned on when secondary hinged gate 21 is locked. Likewise, logic control 12 can detect when latches 20 are unlocked so that it can send a signal to wave generators 6 to prevent them from being turned on.

Additional sensing mechanisms can also be provided on hinged gate 5 and secondary hinged gate 21, along with any other device, such as motion sensors that can detect when waves 10 are being formed and travelling through wave pool 2, such that logic control 12 can lock hinged gate 5 in a closed position when waves are detected as being generated in wave pool 2, and such that logic control 12 can unlock hinged gate 5 and allow it to be opened when waves 10 are no longer being detected as being generated in wave pool 2, in which case, there may be no need to wait a short amount of time thereafter since the sensor will have already detected that waves 10 have subsided and are no longer being generated before opening hinged gate 5.

As described above, by manually turning handle 23 on secondary hinged gate 21, latches 20 can be unlocked, wherein secondary hinged gate 21 can be swung open, which prevents secondary hinged gate 21 from blocking hinged gate 5, wherein hinged gate 5 can then be opened manually. Thus, when wave generators 6 are turned off, and water 16 in wave pool 2 is relatively calm, handle 23 can be used to unlatch secondary hinged gate 21 so that it can be swung open, which in turn, can allow hinged gate 5 to be manually opened, thus allowing surfers to enter into wave pool 2.

In another embodiment, wave pool 2 can also comprise an activation button (not shown) located on the inside of sidewall 1 which can be activated by a lifeguard or surfer while inside wave pool 2. The activation button preferably includes a pressure activated switch to lock and unlock hinged gate 5 located on gateway opening 3, wherein when wave generators 6 are turned off and there is no wave activity in wave pool 2, hinged gate 5 can be opened, and when wave generators 6 are turned on and/or there is wave activity in wave pool 2, hinged gate 5 can remain closed. Note, hinged gate 5 in this case should not include secondary hinged gate 21 that could block the opening of hinged gate 5 and would need to be manually opened to allow hinged gate 5 to open.

In this embodiment, the activation button can comprise a pressure activated switch connected to logic control 12 which can include sensors to determine when wave generators 6 are turned on and off, and when locking mechanisms 7, 9 on hinged gate 5 are engaged to ensure that hinged gate 5 is in a closed and locked position. That way, when wave generators 6 are turned on or when wave activity is sensed within wave pool 2, locking mechanisms 7, 9 can remain locked to keep hinged gate 5 closed. On the other hand, when wave generators 6 are turned off and there is no wave activity in wave pool 2, locking mechanisms 7, 9 can be unlocked to enable hinged gate 5 to be opened.

This added feature is designed for when no lifeguard is available to manually open hinged gate 5, wherein a surfer or lifeguard in wave pool 2 would then be able to press the activation button on the inside of sidewall 1 to open hinged gate 5, i.e., when wave generators 6 are turned off and there are no active waves sensed within wave pool 2, to enable surfers to exit from wave pool 2 when needed. And during the time hinged gate 5 is open, logic control 12 preferably keeps wave generators 6 turned off so that they cannot be turned on until hinged gate 5 is closed and locked. And when wave generators 6 are turned on or there are waves sensed within wave pool 2, hinged gate 5 can remain closed and locked.

The apparatus of the invention preferably comprises a wave pool 2, multiple wave generators 6, at least two sidewalls 1, at least one gateway opening 3 on one or more sidewalls, a hinged gate 5 on each gateway opening 3, along with hinges 4 and gasket 19 to seal gateway opening 3 and locking mechanisms 7, 9, such as electromagnetic locks, on the top and bottom to lock and unlock hinged gate 5. Secondary hinged gate 21 with hinges 25, latches 20 and handle 23 are also preferably provided. This system helps keep hinged gate 5 closed and locked when waves 10 are being generated in wave pool 2, and allows hinged gate 5 to be manually opened when wave generators 6 are turned off, or a short time afterwards.

The apparatus also includes logic control 12 which can be connected to wave generators 6, locking mechanisms 7, 9, such as electromagnetic locks, and optionally latches 20 on secondary hinged gate 21, or any other feasible device, to control when hinged gate 5 and locking mechanisms 7, 9 can be locked and unlocked, when wave generators 6 are turned on and off, along with alternatively determining when secondary hinged gate 21 is locked or unlocked.

Broadly speaking, the apparatus may also comprise a double-locking gateway system like the one described above wherein hinged gate 5 seals an opening on a wall (whether it's on a wave pool or not), and secondary hinged gate 21 with latches 20 and handle 23 helps prevent/block hinged gate 5 from opening.

The invention also comprises a method of opening and closing gateway opening 3 on sidewall 1 of wave pool 2 depending on whether wave generators 6 are turned on or off, and thus allowing surfers to safely enter into and exit from wave pool 2 when wave generators 6 are turned off, and likewise prevent surfers from entering and exiting wave pool 2 when wave generators 6 are turned on.

This method preferably includes a combination of one or more of the following steps:

Providing a wave pool 2 with multiple wave generators 6 on one end and a sloped beach on the opposite end, and two sidewalls 1, one on either side.

Providing at least one gateway opening 3 on at least one sidewall 1 of wave pool and allowing surfers to enter into and exit from wave pool 2.

Providing a hinged gate 5 extended within gateway opening 3 wherein hinged gate 5 is a metal frame 15 with see-through window 17, and wherein hinged gate 5 has hinges 4 on one side and locking mechanisms 7, 9 on the opposite side at the top and bottom thereof, along with central linkage mechanism 18, to lock hinged gate 5 and prevent it from opening.

Providing a logic control 12 wired and connected to wave generators 6 and locking mechanisms 7, 9, such as electromagnetic locks, including central linkage mechanism 18, and operating logic control 12 to lock and unlock hinged gate 5, wherein the method can include unlocking locking mechanisms 7, 9 and allowing hinged gate 5 to be manually opened.

Providing a secondary hinged gate 21 with hinges 25 on a side opposite hinges 4 along with a handle 23 and latches 20 that can be used to lock secondary hinged gate 21 in a closed position. Using handle 23 on secondary hinged gate 21 to operate latches 20 so that they can be connected to and unconnected from complimentary connectors 29 and 31 located on hinged gate 5, wherein with secondary hinged gate 21 in a closed and locked position, hinged gate 5 and secondary hinged gate 21 are secured together and extended parallel to each other and overlapped, thus preventing them from separating from each other, and thus blocking hinged gate 5 and preventing it from being opened. The method also comprises turning handle 23 on secondary hinged gate 21 and unlocking latches 20 and allowing secondary hinged gate 21 to be opened and thus separated from hinged gate 5, and thus, allowing hinged gate 5 to be opened manually by swinging it open about hinges 4, and with hinged gate 5 open, enabling surfers to enter into and/or exit from wave pool 2.

After surfers have passed through gateway opening 3, they can manually close hinged gate 5 until it is locked and manually close secondary hinged gate 21 until latches 20 are connected to complimentary connectors 29 and 31 on hinged gate 5 so that both hinged gate 5 and secondary hinged gate 21 are secured together, which blocks and prevents hinged gate 5 from being opened.

Once surfers enter wave pool 2, logic control 12 can be used to lock locking mechanisms 7, 9 on hinged gate 5 and thus prevent hinged gate 5 from opening, and using logic control 12 to sense that locking mechanisms 7, 9 and hinged gate 5 are locked, thus allowing wave generators 6 to be turned on.

Using logic control 12 to turn on wave generators 6 and create waves 10 in wave pool 2 and causing the waves to travel from the wave-generator end to the sloped beach area to the opposite beach end, and allowing surfers to ride waves 10.

Keeping hinged gate 5 locked while waves pass by and thus preventing water 16 and waves 10 in wave pool 2 from spilling and crashing through gateway opening 3 and into entrance area 8.

At the appropriate time, such as when surfers have completed their rides, using logic control 12 to turn wave generators 6 off, and waiting a few seconds after wave generators 6 are turned off to allow waves 10 to subside and calm down, and after a predetermined amount of time, such as 4 to 10 seconds, using logic control 12 to unlock locking mechanisms 7, 9 on hinged gate 5 and allowing surfers to swim to gateway opening 3 on sidewall 1.

Enabling surfers to turn handle 23 and unlatch secondary hinged gate 21 from hinged gate 5 and then swing secondary hinged gate 21 open and enabling surfers to open hinged gate 5 and step through gateway opening 3 and onto entrance area 8.

Allowing surfers to manually close hinged gate 5 until it is locked and closing secondary hinged gate 21 until latches 20 are connected to complimentary connectors 7 and 9 so that both hinged gate 5 and secondary hinged gate 21 are locked together.

Repeating the steps for each group of surfers entering wave pool 2.

What is claimed is:

1. A wave pool having at least one wave generator, at least one sidewall and a sloped beach, comprising:
a gateway opening on said at least one sidewall for enabling participants to enter into and exit from said wave pool, wherein the bottom edge of said gateway opening is extended above the standing mean water level in said wave pool;
a gate extended within said gateway opening that enables said gateway opening to be opened and closed, wherein when said gate is open, participants can pass through said gateway opening and into and out of said wave pool, and when said gate is closed, it substantially prevents water and wave energy in said wave pool from passing into and through said gateway opening;
a control mechanism connected to said at least one wave generator and said gate wherein said control mechanism has at least one sensor adapted to sense when said at least one wave generator is turned on and creating waves in said wave pool, and to sense when said at least one wave generator is turned off and not creating waves in said wave pool; and
wherein said control mechanism is capable of locking said gate when it senses that said at least one wave generator is turned on and creating waves in said wave pool, and is capable of unlocking said gate when it senses that said at least one wave generator is turned off, or has been turned off for a predetermined amount of time.

2. The wave pool of claim 1, wherein said wave pool comprises two sidewalls and one gateway opening is provided on each of said two sidewalls to enable participants to enter into and exit from said wave pool on either side of said wave pool.

3. The wave pool of claim 1, wherein said gateway opening is sized and shaped to enable participants carrying surfboards to pass through said gateway opening, wherein said gate has at least one hinge that allows it to swing open in one direction away from said wave pool.

4 .The wave pool of claim 1, wherein said gate comprises a frame with a clear window extended across it that enables participants to see into said wave pool.

5. The wave pool of claim 1, wherein an entrance area with a grated floor is provided adjacent said gate, wherein a cavity or reservoir is provided below said entrance area for enabling water drained from said entrance area to be circulated back into said wave pool.

6. The wave pool of claim 1, wherein a locking mechanism is provided on said gate comprising at least a pair of electromagnetic locks that are connected to and can be controlled by said control mechanism, wherein sensors are provided on said gate and/or said locking mechanism so that said control mechanism can sense when said gate is open or closed.

7. The wave pool of claim 1, wherein said gate has a gasket or sealing member thereon such that with said gate in a closed position, said gateway opening is substantially sealed such that water is substantially prevented from passing through said gateway opening.

8. The wave pool of claim 1, wherein a secondary gate that is narrower than said gate is provided on said gateway opening, wherein said secondary gate is hinged on a side opposite a hinge on said gate, wherein in a closed position, said secondary gate is adapted to be positioned substantially parallel to and secured to said gate, wherein in an open position, said secondary gate can swing away from said wave pool, and be disconnected from said gate.

9. The wave pool of claim 8, wherein said secondary gate has latches that are controlled manually by a handle, wherein said secondary gate can be opened and closed by using said handle, and wherein with said secondary gate in said closed position, said latches are adapted to latch onto complimentary locks extended on said gate such that with said secondary gate in said closed position, said secondary gate overlaps and blocks and prevents said gate from being opened, and in said open position, said secondary gate can be swung open and thus enable said gate to be swung open.

10. The wave pool of claim 9, wherein additional sensors are provided on said secondary gate and/or said latches to enable said control mechanism to sense when said secondary gate is in an open or closed position.

11. A method of entering and/or exiting a wave pool having at least one wave generator and a sloped beach, and at least one sidewall, comprising:
providing at least one gateway opening on said at least one sidewall along with a gate extended within said gateway opening wherein said gate can be opened and closed and locked using a locking mechanism;
providing a logic control connected to said at least one wave generator and said locking mechanism and operating said logic control to lock and unlock said gate; and
using said logic control to lock said gate when said at least one wave generator is turned on, and to unlock said gate when said at least one wave generator is turned off, or a predetermined time thereafter.

12. The method of claim 11, wherein said locking mechanism comprises a pair of electromagnetic locks and wherein operating said logic control enables said gate to be opened and closed and placed in a locked position.

13. The method of claim 11, comprising setting said predetermined time to 4 to 10 seconds such that said gate can be unlocked 4 to 10 seconds after said at least one wave generator is turned off and no longer creating waves in said wave pool, wherein sufficient time can be provided for the waves in said wave pool to subside and calm down before said gate is unlocked and opened.

14. The method of claim 11, comprising using a secondary gate with a handle and latches that can lock said secondary gate in a closed position, wherein with said secondary gate in said closed position, said gate and said secondary gate are extended parallel to each other and secured together to prevent them from separating from each other, and thus this securement enables said secondary gate to block and prevent said gate from being opened.

15. The method of claim 14, comprising turning said handle and unlocking said latches and allowing said secondary gate to be opened and thus separating said gate from said secondary gate, and allowing said secondary gate to be opened, and thus allowing said gate to be opened and enabling surfers to enter into and/or exit from said wave pool.

16. The method of claim 14, comprising manually closing said gate until it is locked, followed by manually closing said secondary gate until said latches are connected to complimentary connectors on said gate so that both said gate and said secondary gate are secured together, which blocks and prevents said gate from being opened.

17. The method of claim 11, further comprising using said logic control to sense that said locking mechanism is keeping said gate in a closed position, and allowing said wave generators to be turned on to create waves in said wave pool, wherein by keeping said gate closed and locked, water and waves in said wave pool can be substantially prevented from spilling through said gateway opening and into an entrance area as the waves pass by.

18. The method of claim 11, further comprising using said logic control to sense that said locking mechanism is keeping said gate in an open position, and thus not allowing said wave generators to be turned on to create waves in said wave pool, wherein by keeping said gate unlocked, surfers can open said gate and enter into and/or exit from said wave pool through said gateway opening.

19. A wave pool having at least one wave generator, two sidewalls and a sloped beach, comprising:
a gateway opening on at least one of said two sidewalls for enabling participants to enter into and exit from said wave pool;
a hinged gate extended within said gateway opening that enables said gateway opening to be opened and closed, wherein when said hinged gate is open, participants can pass through said gateway opening and into and out of said wave pool, and when said hinged gate is closed, it substantially prevents water and wave energy in said wave pool from passing into and through said gateway opening;
a control mechanism connected to said at least one wave generator and said hinged gate wherein said control mechanism is adapted with at least one sensor to sense when said at least one wave generator is turned on and when said at least one wave generator is turned off;
wherein said control mechanism is capable of locking said hinged gate when it senses that said at least one wave generator is turned on, and is capable of unlocking said hinged gate when it senses that said at least one wave generator is turned off, or has been turned off for a predetermined amount of time; and
wherein a secondary hinged gate that is narrower than said hinged gate is provided on said gateway opening, wherein said secondary hinged gate is hinged on a side opposite said hinged gate, and wherein in a closed position, said secondary hinged gate is adapted to block and prevent said hinged gate from being opened, and wherein in an open position, said secondary hinged gate can be swung open to enable said gate to be swung open.

20. The wave pool of claim 19, wherein said at least one sensor comprises a sensor that detects when said hinged gate is open or closed, wherein when said hinged gate is open, said control mechanism prevents said at least one wave generator from being turned on, and when said hinged gate is closed, said control mechanism allows said at least one wave generator to be turned on, and where additional sensors are provided on said secondary hinged gate and/or said latches to enable said control mechanism to sense when said secondary hinged gate is in an open or closed position.
